(19) United States
(12) Patent Application Publication
(10) Pub. No.: US 2026/0271122 A1
(43) Pub. Date: Sep. 10, 2026

(54) USER EQUIPMENT, BASE STATION, AND METHOD THEREOF

(71) Applicant: SHARP KABUSHIKI KAISHA, Sakai City, Osaka (JP)

(72) Inventors: FANGYING XIAO, Shanghai (CN); RENMAO LIU, Shanghai (CN)

(21) Appl. No.: 18/714,235

(22) PCT Filed: Nov. 29, 2022
(86) PCT No.: PCT/CN2022/135007

§ 371 Date: May 29, 2024

(30) Foreign Application Priority Data
Dec. 1, 2021 (CN) 202111460612.5

(51) Int. Cl. H04W 76/27; H04W 88/06

(52) U.S. Cl. CPC H04W 76/27; H04W 88/06

(57) ABSTRACT

According to the present invention, provided is a method performed by user equipment (UE) at least capable of performing multi-network association with a first communication network and a second communication network, the method including: when the UE operating in the first communication network needs to leave a radio resource control (RRC) connected state, and when a release without response timer is not running, performing at least one of the following operations: initiating transmission of a UE assistance information message including indication information of requesting to leave the RRC connected state, so as to provide multi-network association assistance information; and starting the release without response timer.

### TECHNICAL FIELD

The present disclosure relates to the technical field of wireless communications. More specifically, the present disclosure relates to user equipment, a base station, and a method thereof.

### BACKGROUND

In recent years, multi-USIM card devices have become increasingly popular. For example, a user installs two USIM cards on a mobile phone supporting a plurality of USIM cards. One of the USIM cards is used for subscribing to private services, and the other USIM card is used for subscribing to office services. Existing devices that support a plurality of USIM cards are implemented on the basis of manufacturers, and have not been standardized by the 3GPP. Therefore, different manufacturers use different implementation means, and behaviors of user equipment (UE) units are likewise different from each other. In existing implementations means, if these USIM cards are respectively registered to networks (the USIM cards may be registered to the same network or respectively registered to two or more networks), UE needs to receive paging from these networks. On the basis of transceiving capabilities of the UE, a possible scenario exists in which, when the UE receives paging of a current network, another network also initiates paging for the UE, or when the UE is communicating with a network, another network initiates paging for the UE. If the UE switches between different networks, a possible result is that the UE can no longer receive data from the current network when the UE switches to another network. This would compromise network performance. For example, the network transmits paging to the UE, but the UE does not receive this page because the UE has switched to another network, or the UE switches to another network and therefore cannot receive scheduling of the current network. Some manufacturers proposed 3GPP standardization study on network accessing behaviors of UE having a plurality of USIM cards and related networks, the benefit of which is that network performance can be improved on the basis of predictable UE behaviors.

On the basis of the above-described reason, in December 2019, a work item for multi-SIM card devices in Release 17 was proposed by vivo at the 3rd Generation Partnership Project (3GPP) RAN#86 plenary meeting (see Non-Patent Document: RP-193263: New WID: Support of Multi-SIM devices in Rel-17), and was approved. One of the objectives of the work item is to define a mechanism for notifying network A when UE leaves network A. Network A is NR, and network B is LTE or NR. The UE is single-Rx/single-Tx, or the UE is dual-Rx/single-Tx.

The present disclosure discusses relevant problems involved in achieving the above work objectives.

In order to address at least some of the aforementioned problems, provided in the present invention are user equipment, a base station, and a method thereof, which can enable user equipment using a multi-network association mode to promptly autonomously release an RRC connection to a network, and reduce signaling overhead.

In order to achieve the above-described objective, according to the present invention, provided is a method performed by user equipment (UE) at least capable of performing multi-network association with a first communication network and a second communication network, the method comprising: when the UE operating in the first communication network needs to leave a radio resource control (RRC) connected state, and when a release without response timer is not running, performing at least one of the following operations: initiating transmission of a UE assistance information message comprising indication information of requesting to leave the RRC connected state, so as to provide multi-network association assistance information; and starting the release without response timer.

Preferably, when the release without response timer expires, the UE performs operations required to be performed upon going to an RRC idle state.

In addition, according to the present invention, provided is a method performed by user equipment (UE) at least capable of performing multi-network association with a first communication network and a second communication network, the method comprising: when the UE operating in the first communication network needs to leave a radio resource control (RRC) connected state, when a prohibit timer is not running, performing at least one of the following operations: initiating transmission of a UE assistance information message comprising indication information of requesting to leave the RRC connected state, so as to provide multi-network association assistance information; starting a release without response timer; and starting the prohibit timer.

Preferably, the prohibit timer is used for prohibiting the UE from initiating transmission of the UE assistance information message for the purpose of multi-network association.

In addition, according to the present invention, provided is a method performed by user equipment (UE) at least capable of performing multi-network association with a first communication network and a second communication network, the method comprising: when the UE operating in the first communication network needs to leave a radio resource control (RRC) connected state, performing at least one of the following operations: initiating transmission of a UE assistance information message comprising indication information of requesting to leave the RRC connected state, so as to provide multi-network association assistance information; and when a release without response timer is not running, starting the release without response timer.

In addition, according to the present invention, provided is a method performed by user equipment (UE) at least capable of performing multi-network association with a first communication network and a second communication network, the method comprising: when the UE operating in the first communication network needs to leave a radio resource control (RRC) connected state, when a release without response timer is not running, performing at least one of the following operations: initiating transmission of a UE assistance information message comprising indication information of requesting to leave the RRC connected state, so as to provide multi-network association assistance information; and when the release without response timer is not running, starting the release without response timer.

In addition, according to the present invention, provided is a method performed by user equipment (UE) at least capable of performing multi-network association with a first communication network and a second communication network, the method comprising: when the UE operating in the first communication network needs to leave a radio resource control (RRC) connected state, and when a prohibit timer is not running, performing at least one of the following operations: initiating transmission of a UE assistance information message comprising indication information of requesting to leave the RRC connected state, so as to provide multi-network association assistance information; when a release without response timer is not running, starting the release without response timer; and starting the prohibit timer.

Additionally, according to the present invention, provided is user equipment, comprising: a processor; and a memory storing instructions, wherein the instructions, when run by the processor, perform the above method.

In addition, according to the present invention, provided is a method performed by a base station, the base station communicating with user equipment (UE) at least capable of performing multi-network association with a first communication network and a second communication network, the method comprising: configuring the UE to provide multi-network association assistance information; and receiving, from the UE operating in the first communication network, a UE assistance information message for providing the multi-network association assistance information.

In addition, according to the present invention, provided is a base station, comprising: a processor; and a memory storing instructions, wherein the instructions, when run by the processor, perform the above method.

### Effect of Invention

### Effect of Invention

According to the present invention, user equipment using the multi-network association means can be enabled to promptly autonomously release an RRC connection to a network, and signaling overhead is reduced.

### BRIEF DESCRIPTION OF THE DRAWINGS

The above and other features of the present disclosure will become more apparent with the following detailed description in conjunction with the accompanying drawings.

FIG. 1 is a flowchart showing a method performed by user equipment according to Embodiment 1 of the present invention.

FIG. 2 is a flowchart showing a method performed by user equipment according to Embodiment 2 of the present invention.

FIG. 3 is a flowchart showing a method performed by user equipment according to Embodiment 3 of the present invention.

FIG. 4 is a flowchart showing a method performed by user equipment according to Embodiment 4 of the present invention.

FIG. 5 is a flowchart showing a method performed by user equipment according to Embodiment 5 of the present invention.

FIG. 6 is a block diagram schematically showing user equipment according to the present invention.

FIG. 7 is a block diagram schematically showing a base station according to the present invention.

### DETAILED DESCRIPTION

The following describes the present disclosure in detail with reference to the accompanying drawings and specific embodiments. It should be noted that the present disclosure should not be limited to the specific embodiments described below. In addition, for simplicity, detailed description of the prior art not directly related to the present disclosure is omitted to prevent confusion in understanding the present disclosure.

The following describes some terms involved in the present disclosure. For the specific meanings of the terms, refer to the latest relevant 3GPP documents, for example, TS 38.300, TS38.331, TS36.300, TS36.331, etc.
NAS: Non-Access Stratum.
AS: Access Stratum.
RRC: Radio Resource Control.
RRC CONNECTED: RRC connected state.
RRC INACTIVE: RRC inactive state.
RRC IDLE: RRC idle state.
RAN: Radio Access Network.
USIM: Universal Subscriber Identity Module.
MUSIM: Multi-Universal Subscriber Identity Module.
Tx: transmitter.
Rx: receiver.
NR: New RAT, New Radio Access Technology.

In the present disclosure, a network, a base station, and a RAN may be used interchangeably. The network may be a Long Term Evolution (LTE) network, an NR network, an enhanced Long Term Evolution (eLTE) network, or another network defined in a subsequent evolved version of the 3GPP.

In the present disclosure, user equipment (UE) may refer to a device that physically supports a plurality of USIM cards (two or more USIM cards). The device is equipped with two or more USIM cards, and each USIM card is associated with one network. The plurality of USIM cards may be from the same operator or different operators. From the perspective of the networks, different USIM cards correspond to different UEs, and each USIM card corresponds to one UE. Unless otherwise specified, the present disclosure does not distinguish therebetween.

Those skilled in the art can easily determine, according to the context, whether UE refers to UE supporting a plurality of USIM cards or UE respectively corresponding to each USIM card in a device supporting a plurality of USIM cards. User equipment configured with a plurality of USIM cards can receive and/or transmit data from and/or to a plurality of networks by using single-Rx/single-Tx or dual-Rx/single-Tx via means such as time division multiplexing, and for UE having two Rxs, the UE can simultaneously receive data from two networks. In addition, the USIM in the present disclosure can be a physical SIM or an eSIM.

In examples of embodiments of the present disclosure, UE is configured with two USIM cards, and those skilled in the art can easily expand the same to cases of a plurality of USIM cards. User equipment (UE) having two USIM cards at least has single-Rx/single-Tx or dual-Rx/single-Tx capabilities. Different UEs corresponding to two USIMs may share one pair of Tx's and Rx's, or may share one Tx but respectively have respective Rx's.

The following describes a procedure of UE initiating, for the purpose of a MUSIM (the UE requests to release an RRC connection to a current network because the UE needs to communicate with another network), a request to a network to release an RRC connection.

In a MUSIM scenario, the UE is in an RRC connected state in network A (i.e., a base station), but the UE needs/wishes to communicate with network B, e.g., establish an RRC connection to network B. In this case, the UE transmits, to network A, indication information of requesting to release a current RRC connection of the UE. Specifically, when UE having and providing MUSIM assistance information needs to leave the RRC_CONNECTED state, if the UE is configured to provide the MUSIM assistance information and the UE needs to leave the RRC_CONNECTED state, the UE performs the following operations:
initiating transmission of a UEAssistanceInformation message so as to provide the MUSIM assistance information; and starting a timer T, and setting the value of the timer to musim-LeaveWithoutResponseTimer.

It should be noted that if the timer T is an optional configuration, the timer T is started only when the UE is configured with musim-LeaveWithoutResponseTimer. When the UE needs to leave the RRC CONNECTED state (for the purpose of the MUSIM), musim-PreferedRRC-State included in the UEAssistanceInformation message may be set to a desired RRC state. The UE may determine, according to whether the UE is configured with a musim-AssistanceConfig field, whether the UE is configured to provide the MUSIM assistance information. The base station configures, via the musim-AssistanceConfig field carried in an RRC message (e.g., an RRCReconfiguration message), the UE to report the assistance information. In addition, the UE being configured to provide the MUSIM assistance information may be replaced with the UE being configured to indicate a preference for leaving the RRC connected state for the purpose of the MUSIM. The timer T may also be referred to as an automatic release timer or a release without response timer.

In addition, in the present disclosure, if the UE initiates transmission of the UEAssistanceInformation message so as to provide the MUSIM assistance information, the following operation is performed:
if the UE needs to leave the RRC_CONNECTED state, setting musim-PreferedRRC-State to a desired RRC state.

For UE configured with the musim-AssistanceConfig field, after the UE transmits, to network A for the purpose of the MUSIM (e.g., the UE needs to establish an RRC connection to another network), an RRC message (i.e., the RRC message UEAssistanceInformation includes the musim-PreferedRRC-State field) for requesting to release an RRC connection, before the UE receives, from network A, an RRCRelease message for releasing the RRC connection or before the timer T expires, the UE, for the purpose of the MUSIM, triggers a procedure of providing assistance information so as to leave the RRC state. In this case, since the UE has indicated to the network that the UE wants the network to release the current RRC connection, it is not necessary to again transmit, to the network, the RRC message for requesting to release the RRC connection, thereby reducing signaling overhead. The following provides embodiments to achieve the objective.

### Embodiment 1

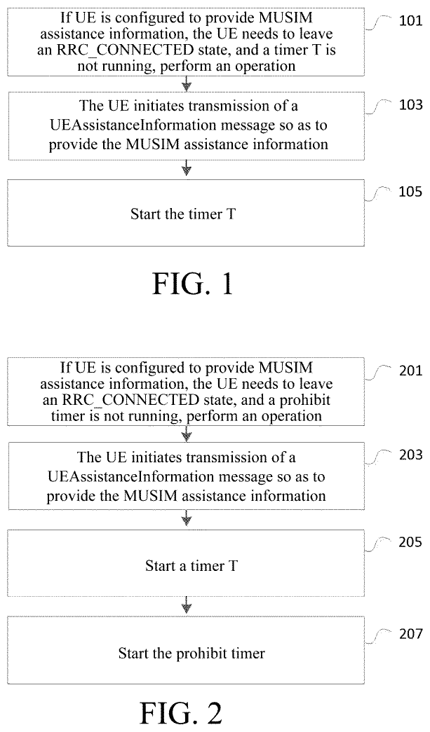

FIG. 1 is a flowchart showing a method performed by user equipment according to Embodiment 1 of the present invention.

A timer T is used for prohibiting UE from transmitting, to a network for the purpose of a MUSIM, a UEAssistanceInformation message including indication information of requesting to leave an RRC connected state. That is, when the timer T is running, the UE is not allowed to transmit, to the network for the purpose of the MUSIM, the UEAssistanceInformation message including the indication information of requesting to leave the RRC connected state.

Specifically, when the UE having and providing MUSIM assistance information needs to leave the RRC_CONNECTED state, the following is performed:

As shown in FIG. 1, in step 101, if the UE is configured to provide the MUSIM assistance information (or is configured with musim-AssistanceConfig), the UE needs to leave the RRC CONNECTED state, and the timer T is not running, performing at least one of the following operations:
(1) in step 103, initiating, by the UE, transmission of a UEAssistanceInformation message so as to provide the MUSIM assistance information; and
(2) in step 105, starting the timer T, and setting the value of the timer to musim-LeaveWithoutResponseTimer (the operation is performed only when the UE is configured with musim-Leave WithoutResponseTimer).

It should be noted that embodiments achieved by changing the order of performing (1) and (2) described above also fall within the scope of protection of the present disclosure.

In addition, in the embodiments of the present disclosure, when the timer T expires, the UE performs operations required to be performed upon going to RRC_IDLE (performs the actions upon going to RRC_IDLE), i.e., releasing a current RRC connection (or leaving the RRC_CONNECTED state), and going to an RRC_IDLE state. Operations performed by the UE going to the RRC_IDLE state may include resetting a Medium Access Control (MAC), releasing all radio resources (including releasing a radio link control (RLC) entity, a backhaul adaptation protocol (BAP) entity, MAC configurations, packet data convergence protocol (PDCP) entities and service data adaptation protocol (SDAP) entities of all established radio bearers, and a backhaul (BH) RLC channel), and indicating, to an upper layer, release of an RRC connection, a release cause, etc.

It should be noted that in the present disclosure, the operations of determining whether the timer is running and/or starting the timer need to be performed only when the UE is configured with a parameter corresponding to the timer. For example, in Embodiment 1, the operation of determining whether the timer T is not running is performed only when the UE is configured with musim-Leave WithoutResponseTimer.

### Embodiment 2

FIG. 2 is a flowchart showing a method performed by user equipment according to Embodiment 2 of the present invention.

A prohibit timer different from the timer T is defined to prohibit the UE from transmitting, to a network for the purpose of a MUSIM, a UEAssistanceInformation message including indication information of requesting to leave an RRC connected state. That is, when the prohibit timer is running, the UE is not allowed to transmit, to the network for the purpose of the MUSIM, the UEAssistanceInformation message including the indication information of requesting to leave the RRC connected state.

Specifically, when the UE having and providing MUSIM assistance information needs to leave the RRC CONNECTED state, the following is performed:

As shown in FIG. 2, in step 201, if the UE is configured to provide the MUSIM assistance information (or is configured with musim-AssistanceConfig), the UE needs to leave the RRC CONNECTED state, and the prohibit timer is not running, performing at least one of the following operations:
(1) in step 203, initiating, by the UE, transmission of a UEAssistanceInformation message so as to provide the MUSIM assistance information;
(2) in step 205, starting the timer T, and setting the value of the timer to musim-Leave WithoutResponse Timer (the operation is performed only when the UE is configured with musim-Leave WithoutResponseTimer); and
(3) in step 207, starting the prohibit timer, and setting the value of the prohibit timer to musim-PreferedRRCStateProhibitTimer (the operation is performed only when the UE is configured with musim-PreferedRRCStateProhibitTimer).

It should be noted that embodiments achieved by changing the order of performing (1) to (3) described above also fall within the scope of protection of the present disclosure.

For UE configured with the musim-AssistanceConfig field, after the UE transmits, to network A for the purpose of the MUSIM (e.g., the UE needs to establish an RRC connection to another network), an RRC message (i.e., the RRC message UEAssistanceInformation includes the musim-PreferedRRC-State field) for requesting to release an RRC connection, before the UE receives, from network A, an RRCRelease message for releasing the RRC connection or before the timer T expires, the UE, for the purpose of the MUSIM, triggers a procedure of providing assistance information so as to leave the RRC state. In this case, since the UE has indicated to the network that the UE wants the network to release the current RRC connection, the timer T is running. When the timer T expires, the UE releases the current RRC connection. According to an existing procedure, when the UE again transmits the RRC message (i.e., transmitting the UEAssistanceInformation message including the musim-PreferedRRC-State field) for requesting to release the RRC connection, the timer T is restarted, so that the UE cannot promptly autonomously release the RRC connection to network A. The following provides embodiments to solve the problem.

### Embodiment 3

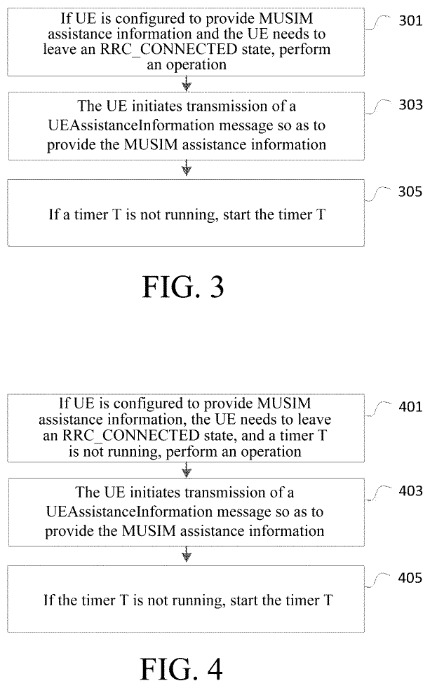

FIG. 3 is a flowchart showing a method performed by user equipment according to Embodiment 3 of the present invention.

When the UE again transmits an RRC message (i.e., transmitting a UEAssistanceInformation message including a musim-PreferedRRC-State field) for requesting to release an RRC connection, a timer T is started only when the timer T is not running.

Specifically, when the UE having and providing MUSIM assistance information needs to leave an RRC_CONNECTED state, the following is performed:

As shown in FIG. 3, in step 301, if the UE is configured to provide the MUSIM assistance information (or is configured with musim-AssistanceConfig), and the UE needs to leave the RRC_CONNECTED state, performing at least one of the following operations:
(1) in step 303, initiating, by the UE, transmission of a UEAssistanceInformation message so as to provide the MUSIM assistance information; and
(2) in step 305, if the timer T is not running, starting the timer T, and setting the value of the timer to musim-LeaveWithoutResponseTimer (the operation needs to be performed only when the UE is configured with musim-LeaveWithoutResponseTimer).

In addition, Embodiment 1 or Embodiment 2 may be respectively combined with Embodiment 3 to achieve a new Embodiment 4 and Embodiment 5.

### Embodiment 4

FIG. 4 is a flowchart showing a method performed by user equipment according to Embodiment 4 of the present invention.

Specifically, when the UE having and providing MUSIM assistance information needs to leave an RRC_CONNECTED state, the following is performed:

As shown in FIG. 4, in step 401, if the UE is configured to provide the MUSIM assistance information (or is configured with musim-AssistanceConfig), the UE needs to leave the RRC CONNECTED state, and a timer T is not running, performing at least one of the following operations:
(1) in step 403, initiating, by the UE, transmission of a UEAssistanceInformation message so as to provide the MUSIM assistance information; and
(2) in step 405, if the timer T is not running, starting the timer T, and setting the value of the timer to musim-LeaveWithoutResponse Timer (the operation is performed only when the UE is configured with musim-LeaveWithoutResponseTimer).

It should be noted that embodiments achieved by changing the order of performing (1) and (2) described above also fall within the scope of protection of the present disclosure.

### Embodiment 5

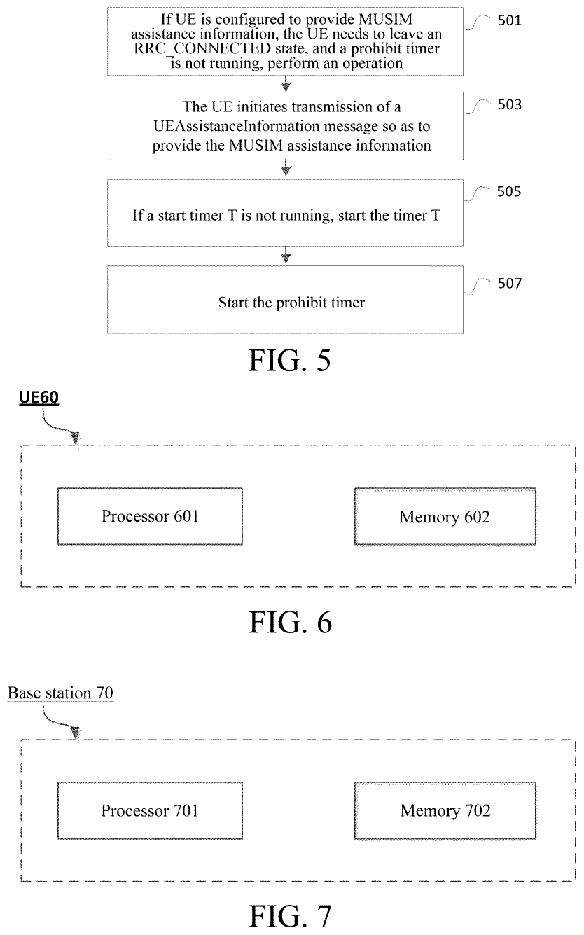

FIG. 5 is a flowchart showing a method performed by user equipment according to Embodiment 5 of the present invention.

Specifically, when the UE having and providing MUSIM assistance information needs to leave an RRC_CONNECTED state, the following is performed:

As shown in FIG. 5, in step 501, if the UE is configured to provide the MUSIM assistance information (or is configured with musim-AssistanceConfig), the UE needs to leave the RRC_CONNECTED state, and a prohibit timer is not running, performing at least one of the following operations:
(1) in step 503, initiating, by the UE, transmission of a UEAssistanceInformation message so as to provide the MUSIM assistance information;
(2) in step 505, if a timer T is not running, starting the timer T, and setting the value of the timer to musim-LeaveWithoutResponseTimer (the operation is performed only when the UE is configured with musim-LeaveWithoutResponseTimer); and
(3) in step 507, starting the prohibit timer, and setting the value of the prohibit timer to musim-PreferedRRCStateProhibitTimer (the operation is performed only when the UE is configured with musim-PreferedRRCStateProhibitTimer).

It should be noted that embodiments achieved by changing the order of performing (1) to (3) described above also fall within the scope of protection of the present disclosure.

The following describes the meaning of some messages or fields involved in the present disclosure.

The UEAssistanceInformation message is used for indicating UE assistance information to the network.

The musim-AssistanceConfig field (which may also be referred to as the musim-AssistanceConfig-Leave field) configures the UE to report the assistance information, that is, configures the UE to report the release preference thereof for the purpose of the MUSIM. The base station may instruct, via the musim-AssistanceConfig field carried in the RRC message (e.g., the RRCReconfiguration message), the UE to report the release preference thereof for the purpose of the MUSIM.

musim-PreferredRRC-State indicates the UE's preferred RRC state when leaving the RRC CONNECTED state (or indicates that the UE prefers to leave the RRC state), and the value thereof may be IDLE or INACTIVE or outOfRRCConnected. If this field is set to IDLE, it is indicated that the UE prefers to be released from the RRC connected state and transition to the RRC idle state. If this field is set to INACTIVE, it is indicated that the UE prefers to be released from the RRC connected state and transition to the RRC inactive state. If this field is set to outOfRRCConnected, it is indicated that the UE prefers to release the RRC connection, but has no preferred RRC state to transition to. outOfRRCConnected is only for indicating that the UE desires the network to release the current RRC connection, but does not indicate any RRC state that the UE desires to transition to after the RRC connection is released. In addition, the values of the musim-PreferredRRC-State field may be the same as the values of the preferredRRC-State field, or may be a subset of the values of the preferredRRC-State field. For example, the values of the musim-PreferredRRC-State field are {idle, inactive} or {idle, inactive, outOfConnected} . For example, if this field is set to idle, it is indicated that the UE prefers to be released from the RRC connected state and transition to the RRC idle state (the value idle is indicated if the UE prefers to be released from RRC_CONNECTED and transition to RRC IDLE). If this field is set to inactive, it is indicated that the UE prefers to be released from the RRC connected state and transition to the RRC inactive state. If this field is set to outOfConnected, it is indicated that the UE prefers to release the RRC connection and has no preferred RRC state to transition to.

The value of the timer T is configured for the UE by the base station via the musim-Leave WithoutResponse Timer field carried in the RRC message transmitted to the UE, and musim-LeaveWithoutResponseTimer indicates the time (or the timer) used by the UE to leave the RRC_CONNECTED state without waiting for a network response. When the timer T expires, the UE, for the purpose of the MUSIM, automatically leaves the RRC_CONNECTED state and transitions to RRC_IDLE. If musim-LeaveWithoutResponse Timer is mandatory, the musim-AssistanceConfig field may not need to be configured. Correspondingly, determination of whether the musim-AssistanceConfig field is configured may all be replaced with whether the musim-LeaveWithoutResponseTimer field is configured.

The value of the prohibit timer is configured for the UE by the base station via the musim-PreferedRRCStateProhibitTimer field carried in the RRC message transmitted to the UE. musim-PreferedRRCStateProhibitTimer is a prohibit timer for reporting of release preference assistance information for the purpose of the MUSIM, i.e., for prohibiting the UE from frequently transmitting, to the base station, the UEAssistanceInformation message including the musim-PreferredRRC-State field.

### Variant Embodiment

Hereinafter, FIG. 6 is used to illustrate user equipment that can perform the method performed by user equipment described in detail above in the present invention as a variant embodiment.

FIG. 6 shows a block diagram of user equipment (UE) according to the present invention.

As shown in FIG. 6, the user equipment (UE) 60 includes a processor 601 and a memory 602. The processor 601 may include, for example, a microprocessor, a microcontroller, an embedded processor, and the like. The memory 602 may, for example, include a volatile memory (for example, a random access memory (RAM)), a hard disk drive (HDD), a non-volatile memory (for example, a flash memory), or other memories. The memory 602 has program instructions stored thereon. The instructions, when run by the processor 601, can perform the above method performed by user equipment described in detail in the present invention.

Hereinafter, FIG. 7 is used to illustrate a base station that can perform the method performed by a base station described above in the present invention as a variant embodiment.

FIG. 7 is a block diagram showing a base station according to the present invention.

As shown in FIG. 7, the base station 70 includes a processor 701 and a memory 702. The processor 701 may include, for example, a microprocessor, a microcontroller, an embedded processor, and the like. The memory 702 may, for example, include a volatile memory (for example, a random access memory (RAM)), a hard disk drive (HDD), a non-volatile memory (for example, a flash memory), or other memories. The memory 702 has program instructions stored thereon. The instructions, when run by the processor 701, can execute the foregoing method performed by a base station described in detail in the present invention.

Specifically, the base station according to the present invention communicates with user equipment (UE) at least capable of performing multi-network association with a first communication network and a second communication network. The base station configures the UE to provide multi-network association assistance information, and receives, from the UE operating in the first communication network, a UE assistance information message for providing the multi-network association assistance information.

The computer-executable instructions or program for implementing the functions of the embodiments of the present disclosure may be recorded on a computer-readable storage medium. The corresponding functions may be achieved by reading programs recorded on the recording medium and executing the programs by a computer system. The so-called “computer system” may be a computer system embedded in the device, which may include operating systems or hardware (for example, peripherals). The “computer-readable storage medium” may be a semiconductor recording medium, an optical recording medium, a magnetic recording medium, a short-time dynamic memory program recording medium, or any other recording medium readable by a computer.

Various features or functional modules of the device used in the above embodiments may be implemented or executed via circuits (for example, monolithic or multi-chip integrated circuits). Circuits designed to execute the functions described in the present specification may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of the advances in semiconductor technology, one or a plurality of embodiments of the present disclosure may also be implemented using these new integrated circuit technologies.

Furthermore, the present disclosure is not limited to the embodiments described above. Although various examples of the described embodiments have been described, the present disclosure is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present disclosure have been described in detail above with reference to the accompanying drawings. However, the specific structures are not limited to the above embodiments. The present disclosure also includes any design modifications that do not depart from the substance of the present disclosure. In addition, various modifications may be made to the present disclosure within the scope of the claims. Embodiments resulted from the appropriate combinations of the technical means disclosed in different embodiments are also included within the technical scope of the present disclosure. In addition, components with the same effect described in the above embodiments may be replaced with one another.

1. A method performed by user equipment (UE), the method comprising
in a case that the UE is configured to provide Multi-Universal Subscriber Identity Module (MUSIM) assistance information, the UE needs to leave a radio resource control (RRC) connected (RRC_CONNECTED) state and a timer is not running:
initiating, transmission of a UEAssistanceInformation message to provide the MUSIM assistance information for leaving RRC CONNECTED state; and
starting the timer with a timer value set to a musim-LeaveWithoutResponseTimer which is configured by an RRC message and is used to indicate the timer for to leave RRC_CONNECTED state without network response.

2. User equipment (UE), comprising:
a processor configured to:
in a case that the UE is configured to provide Multi-Universal Subscriber Identity Module (MUSIM) assistance information, the UE needs to leave radio resource control (RRC) connected (RRC CONNECTED) state and a timer is not running:
initiate transmission of a UEAssistanceInformation message to provide the MUSIM assistance information for leaving the RRC_CONNECTED state; and
start the timer with a timer value set to a musim-LeaveWithoutResponseTimer which is configured by an RRC message and is used to indicate the timer for to leave the RRC_CONNECTED state without network response.
